(19) United States
(12) Patent Application Publication
(10) Pub. No.: US 2011/0245420 A1
(43) Pub. Date: Oct. 6, 2011

(54) COPOLYMER INCLUDING POLYLACTIC ACID, ACRYLIC ACID AND POLYETHYLENE GLYCOL AND PROCESSES FOR MAKING THE SAME

(76) Inventors: Rahul M. Rasal, St. Paul, MN (US); Douglas E. Hirt, Seneca, SC (US)

(21) Appl. No.: 13/129,234

(22) PCT Filed: Sep. 24, 2009
(86) PCT No.: PCT/US09/58126

§ 371 Date: Jun. 20, 2011

Related U.S. Application Data
(60) Provisional application No. 61/114,118, filed on Nov. 13, 2008.

(51) Int. Cl. C08L 51/08; C08F 220/06; C08L 33/02

(52) U.S. Cl. 525/63; 525/190

(57) ABSTRACT

The present invention relates to polymer compositions having a polylactic acid backbone with improved toughness, modulus and/or strength. The present invention further relates to films and articles including the polymer compositions and methods of making the polymer compositions.

### STATEMENT OF PRIORITY

This application claims the benefit, under 35 U.S.C. §119(e), of U.S. Provisional Application No. 61/114,118, filed Nov. 13, 2008, the entire contents of which are incorporated by reference herein.

### STATEMENT OF GOVERNMENT SUPPORT

The present invention was funded at least in part by government support under National Science Foundation (NSF) Award Number EEC-9731680 from The Engineering Research Centers Program of the National Science Foundation. The United States Government has certain rights in this invention.

### FIELD OF THE INVENTION

The present invention relates generally to a copolymer including polylactic acid and polymers that provide toughness and/or stiffness properties to the copolymer and processes for making the copolymer. In particular, the present invention relates to a copolymer having a polylactic acid backbone with improved toughness, modulus and/or strength compared to conventional processes for toughening polylactic acid and the conventional product resulting, therefrom.

### BACKGROUND OF THE INVENTION

The market for renewable-resource-derived, biodegradable polymers is growing at least due to environmental concerns and sustainability issues associated with petroleum-based polymers (Eling et al. Biodegradable materials of poly(L-lactic acid): 1. Melt-spun and solution spun fibers. Polymer 23:1587-93 (1982) and Schmack et al. Biodegradable fibers of poly(L-lactide) produced by high-speed melt spinning and spin drawing. J Appl Polym Sci 73:2785-97 (1999)). Polylactic acid (PLA) is a renewably derived (from corn starch, sugar, etc.), biodegradable, and bioabsorbable thermoplastic polyester that exhibits desirable processability and biocompatibility and generally requires 25-55% less energy to produce than petroleum-based polymers (Ray et al. Biodegradable polylactide and its nanocomposites: opening a new dimension for plastics and composites. Macromol Rapid Commun 24:815-40 (2003); Gottschalk et al. Hyperbranched polylactide copolymers. Macromolecules 39:1719-23 (2006); and Vink et al. Application of life cycle assessment to NatureWorks™ polylactide (PLA) production. Polym Degrad Stab 80:403-19 (2003)). However, the use of PLA in certain applications has been limited by its poor toughness (less than 10% elongation at break) and lack of reactive functional groups (Rasal et al. Toughness decrease of PLA-PHBHHx blend films upon surface-confined photopolymerization. J Biomed Mater Res Part A DOI: 10.1002/jbm.a.32009 (2008)).

PLA has been toughened using a variety of plasticizers, stereochemical and processing manipulations, and biodegradable as well as nonbiodegradable rubbery (i.e., low T_{g}) polymers (Anderson et al. Toughening polylactide. Polymer Reviews 48:85-108 (2008)). These approaches often lead to significant stiffness (i.e., modulus) loss, rendering resultant formulations unsuitable for certain applications. Reactive groups have also been introduced onto PLA to create bioactive surfaces for biomedical applications and tailored surfaces for commodity applications (e.g., friction modification, anti-fogging, and adhesion). However, the solvents and reagents involved in these surface-modification protocols often affect PLA bulk properties, especially toughness (Rasal et al. (2008) and Rasal et al. Effect of the photoreaction solvent on surface and bulk properties of poly(lactic acid) and poly(hydroxyalkanoate) films. J Biomed Mater Res Part B Appl: 85B:564-72 (2008)). Examples of specific approaches to provide a PLA composition include, but are not limited to, U.S. Pat. Nos. 5,952,433; 7,053,151 and 7,351,785.

The present invention overcomes previous shortcomings in the art by providing a PLA composition having improved properties related to toughness, modulus and/or strength and by further providing processes for making the same.

### SUMMARY OF THE INVENTION

The present invention provides a polymer composition having an increased toughness, slower degradation rate, hydrophilicity and/or increased number of reactive side-chain groups when compared to conventional PLA compositions.

In one embodiment, the invention encompasses a polymer composition comprising a polylactic acid polymer composition grafted to (a) a stiffening polymer composition, and subsequently physically blended with or covalently bonded to (b) a toughening polymer composition.

Embodiments of the present invention further provide a polymer composition comprising a polylactic acid polymer grafted to (a) an acrylic acid polymer composition present in an amount of about 0 to about 50 weight percent, and subsequently physically blended with or covalently bonded to (b) a polyethylene glycol polymer composition present in an amount of about 0 to about 50 weight percent. In further aspects of the invention, the polymer composition has improved mechanical properties.

Embodiments of the present invention further encompass a polymer composition comprising a polylactic acid polymer grafted to (a) a stiffening polymer composition, and subsequently physically blended with or covalently bonded to (b) a toughening polymer composition. In some embodiments, the film is formed from a polymer composition comprising a polylactic acid polymer grafted to (a) an acrylic acid polymer composition present in an amount of about 0 to about 50 weight percent, and subsequently physically blended with or covalently bonded to (b) a polyethylene glycol polymer composition present in an amount of about 0 to about 50 weight percent. According to further aspects of the invention, the film has improved mechanical properties.

Further embodiments of the invention provide a fiber and/or an article comprising the polymer compositions described herein.

According to further embodiments, the present invention includes a method of making a grafted polylactic acid polymer composition, the method comprises (a) mixing a polylactic acid polymer composition, an initiator and a stiffening polymer composition in a reaction vessel under conditions suitable to form a polymer composition comprising a polylactic acid polymer and a stiffening polymer, and (b) adding a toughening polymer composition to the reaction vessel under conditions suitable to form a polylactic acid, stiffening polymer and toughening polymer blend to provide the grafted polylactic acid polymer composition. In some embodiments, the method comprises (a) mixing a polylactic acid polymer, an initiator and an acrylic acid polymer composition in a reaction vessel under conditions suitable to form a polymer composition comprising a polylactic acid and acrylic acid polymer blend, and (b) adding a polyethylene glycol polymer composition to the reaction vessel under conditions suitable to form a polylactic acid, acrylic acid and polyethylene glycol polymer blend to provide the grafted polylactic acid polymer composition. In further embodiments, the method further comprises subjecting a dried polylactic acid polymer blend, including, for example, acrylic acid and polyethylene glycol polymer, to an extrusion process wherein a rotating screw speed is no less than about 20 rpm and/or the heat applied to the polymer blend is in a range of about 170° C. to about 190° C. In still further embodiments, the heat applied to the polymer blend during the extrusion process is less that the amount of heat applied to a conventional polylactic acid polymer.

Embodiments of the present invention further provide a polymer composition comprising a polylactic acid as described herein for use in consumer packaging and biomedical applications. The polymer composition described herein may have properties that render the composition eco-friendly, biocompatible and having enhanced processability, and/or enhanced energy savings potential.

Other embodiments of the present invention are provided in the following brief description of the drawings and detailed description.

### BRIEF DESCRIPTION OF THE DRAWINGS

FIG. 1 illustrates the miscibility and crystallization behavior of films according to embodiments of the present invention. (A) Dynamic tangent loss (tan δ) as a function of temperature pure PLA and its reactive blends. (B) Differential scanning, calorimetry (DSC) scans of melt quenched (a) pure PLA, (b) PLA-g-PAA(3%)/PEG(10%), (c) PLA-g-PAA(10%)/PEG(10%), and (d) PLA/PEG(10%).

FIG. 2 illustrates effects on toughness of a polymer composition according to embodiments of the present invention. (a) Toughness and (b) Representative stress-strain curves of neat PLA and its reactive blends. Error bars represent 95% confidence intervals.

FIG. 3 illustrates effects on stress (Young's modulus) and ultimate tensile strength on the polymer composition according to embodiments of the present invention. (a) Young's modulus and (b) Ultimate tensile strength of neat PLA and its reactive blends. Error bars represent 95% confidence intervals.

FIG. 4 illustrates the presence of reactive acid groups available for subsequent binding or conjugation on films according to embodiments of the present invention. (a) Toluidine-blue-stained images of neat PLA, which did not show any significant staining, (b) Toluidine-blue-stained images of PLA-g-PAA(3%)/PEG(10%), and (c) Toluidine-blue-stained images of PLA-g-PAA(10%)/PEG(10%) where the color intensity increased with acid concentration for both FIGS. 4b and 4c revealing the presence of reactive acid groups on the film surfaces.

### DETAILED DESCRIPTION

The foregoing and other aspects of the present invention will now be described in more detail with respect to other embodiments described herein.

It should be noted that, as used herein, “a,” “an” or “the” can mean one or more than one. Also as used herein, “and/or” refers to and encompasses any and all possible combinations of one or more of the associated listed items, as well as the lack of combinations when interpreted in the alternative (“or”).

Furthermore, the term “about,” as used herein when referring to a measurable value such as an amount of a compound or agent of this invention, dose, time, temperature, and the like, is meant to encompass variations of ±20%, ±10%, ±5%, ±1%, ±0.5%, or even ±0.1% of the specified amount.

Throughout this application, various, patents, patent publications and non-patent publications are referenced. The disclosures of these publications in their entireties are incorporated by reference into this application in order to more fully describe the state of the art to which this invention pertains.

As used herein, “polymer” refers to a macromolecule formed by the union of repeating structural units, i.e., monomers. The units can be composed of a natural and/or synthetic material.

As used herein, “polymer blend” refers to the polymer composition resulting from the blending of one or more polymers before the polymers are formed into fibers or films, typically at a temperature above the melting point of the polymer having the highest melting point and below the temperature corresponding to the decomposition point of the polymer having the lowest decomposition point. The polymer blend generally has a more integral association among polymer constituents in comparison to polymers that are blended after being formed into fibers or films. Additionally, the polymer blend may constitute a new composition with distinct physical properties.

As used herein, a “toughening” polymer, as understood by one of ordinary skill in the art, refers to a polymer composition that imparts properties of high elongation and/or imparts high tensile and/or shear strengths to other polymers. Such polymers are known in the art as are the tests to assess the toughness of the resultant polymer.

As used herein, a “stiffening” polymer, as understood by one of ordinary skill in the art, refers to polymers that decrease the flexible (elasticity) of other polymers. Such polymers are known in the art as are the tests to assess the stiffness of the resultant polymer.

As used herein, “covalent bonding” refers to the chemical link between atoms characterized by the sharing of electrons in the region between atoms or atoms and other covalent bonds.

As used herein, “grafted” refers to a copolymer composition having a main backbone chain of atoms with various side chains attached thereto wherein the side chains include different atoms and/or functional groups from those in the main chain. The main chain may be a copolymer or may be derived from a single monomer.

The present invention is based on the discovery that a novel reactive-blending approach involving a combination of polymers with complementary properties, polyacrylic acid (PAA) and polyethylene glycol (PEG), can achieve polylactic acid (PLA) toughening, without significant modulus or ultimate tensile strength (UTS) losses. In addition, this technology introduces into the PLA matrix a controlled concentration of reactive acid groups that can be readily conjugated with a variety of biomolecules containing various functional groups using reactive chemistry, for example, carbodiimide (Janorkar et al. Grafting amine-terminated branched architectures from poly(L-lactide) film surfaces for improved cell attachment. J Biomed Mater Res Part B: Appl Biomater 81B:142-52 (2007) and Zhang et al. Surface grafting poly(ethylene glycol) (PEG) onto poly(ethylene-co-acrylic acid) films. Langmuir 22:6851-57 (2006)), thionyl chloride (Zhang et al. Subsurface formation of amide in polyethylene-co-acrylic acid film: a potentially useful reaction for tethering biomolecules to a solid support. Macromolecules 32:2149-55 (1999), or phosphorous pentachloride (Luo et al. Surface modification of ethylene-co-acrylic acid copolymer films: addition of amide groups by covalently bonded amino acid intermediates. J Appl Polym Sci 92:1688-94 (2004)) chemistry.

Thus, in one embodiment, the invention provides a polymer composition comprising a polylactic acid polymer composition grafted to (a) a stiffening polymer composition, and subsequently physically blended with or covalently bonded to (b) a toughening polymer composition. In some embodiments, the polylactic acid polymer composition grafted to the stiffening polymer composition is physically blended with the toughening polymer composition. In some embodiments, the polylactic acid polymer composition grafted to the stiffening polymer composition is covalently bonded to the toughening polymer composition.

As noted above, the polylactic acid polymer composition comprises a biodegradable polyester derived from renewable resources, such as corn starch, sugar, etc. According to embodiments of the present invention, the polylactic acid polymer composition can be derived from a commercial source, or the polylactic acid polymer composition can be prepared using techniques well known to those skilled in the art. For example, a polylactic acid polymer can be produced by synthetic methods such as ring-opening polymerization of lactide or direct condensation polymerization from lactic acid wherein starting materials include L-lactide or D-lactide as a dimer of lactic acid, or mesolactide. L-lactic acid or D-lactic acid as appropriate. In particular embodiments of the present invention, the polymer composition described herein was produced using polylactic acid pellets having a molecular weight of about 110 kDa as supplied by NatureWorks L.L.C.

According to embodiments of the present invention, the polylactic acid polymer composition can be a homopolymer or it can be copolymerized with glycolides, lactones and/or other monomers. Examples of polymers that may be used to form a copolymer with polylactic acid suitable to be modified according to the methods of the present invention include, but are not limited to, poly(glycolide), poly(δ-valerolactone), ply(ε-caprolactone), poly(hydroxyalkanoate) (PHA) copolymers, poly(1,5-dioxepane-2-one), poly(trimethylene carbonate), poly(ethylene glycol), poly(propylene glycol), poly(tetrafluoroethylene oxide-co-difluoromethylene oxide) α,ω-diol and other segmented perfluoropolyethers. In some embodiments, the polylactic acid polymer composition comprises poly(lactic-co-glycolic) acid (PLGA). In further embodiments, the polylactic acid polymer composition is about 0%, 1%, 5%, 10%, 15%, 20%, 25%, 30%, 35%, 40%, 45% or 50% glycolide, lactone and/or other monomer. Additionally, polylactic acid homopolymers or copolymers of any molecular weight can be modified using this technology.

According to further embodiments of the present invention, the stiffening polymer is present in an amount of about 0 to 50 weight percent. In some embodiments, the stiffening polymer is present in an amount of about 1, 5, 10, 15, 20, 25, 30, 35, 40, 45 or 50 weight percent. In further embodiments, the stiffening polymer composition is an acrylic polymer. Acrylic polymers are commercially available or readily prepared by one skilled in the art. In some embodiments, the stiffening polymer is selected from the group consisting of acrylic acid, acrylamide, methacrylic acid, methyl methacrylate, vinyl acetate, vinyl chloride, styrene, polystyrene, N-isopropylacrylamide, methyl acrylate, ethyl acrylate, butyl acrylate, 2-ethylhexyl acrylate, tertiarybutyl acrylate, tertiarybutyl methacrylate, isobutyl acrylate, 2-hydroxyethyl acrylate, 2-hydroxypropyl acrylate, butanediol monoacrylate, lauryl acrylate, dimethylaminoethyl acrylate, ethyldiglycol acrylate, cyclohexyl methacrylate, N-vinylformamid, N-vinylpyrrolidone, dihydrodicyclopentadienyl acrylate, dimethylaminoethyl acrylate, butanediol monoacrylate, 2-hydroxypropyl acrylate, 2-hydroxyethyl acrylate and 2-hydroxyethyl methacrylate, including any combination thereof.

In particular embodiments, the stiffening polymer includes an acrylic acid composition. The acrylic acid composition includes acrylic acid (or prop-2-enoic acid), which is the simplest unsaturated carboxylic acid having a vinyl group at the α-carbon position and a carboxylic acid terminus. Acrylic acid and its esters readily combine with themselves or other monomers to provide homopolymers or copolymers. Acrylic acid compositions can be prepared using techniques well known to those skilled in the art. Alternatively, the acrylic acid composition can be readily obtained from a commercial source. In particular embodiments of the present invention, acrylic acid (99.5% w/w) was obtained from Acros Organics. In some embodiments, the acrylic acid composition is present in an amount of about 0 to 50 weight percent, for example, about 1, 5, 10, 15, 20, 25, 30, 35, 40, 45 or 50 weight percent. In some embodiments, acrylic acid is present in an amount of about 10 weight percent. In further embodiments, the acrylic acid composition is present in an amount of about 3 weight percent.

In some embodiments of the present invention, the toughening polymer composition comprises a polyether or a polyester. In some embodiments, the toughening polymer comprises a polyalkylene glycol. In further embodiments, the toughening polymer composition is selected from the group consisting of polyethylene glycol, poly(ε-caprolactone), a poly(hydroxyl alkanoate) copolymer, poly(butylene adipate-co-terephthalate), poly(tetramethylene adipate-co-terephthalate), poly(para-dioxanone), polypropylene carbonate) and polybutylene succinate), including any combination thereof.

In particular embodiments, the toughening polymer composition comprises polyethylene glycol. Polyethylene glycol is a polyether having the general formula:

HO(CH₂CH₂O)ₙH,

where n can range from about 1 to about 4000 or more. Polyethylene glycol can range from an average molecular weight of about 1 to about 100,000. As understood by one skilled in the art, polyethylene glycol can be readily synthesized or is a commercially available product that can be readily obtained. In particular embodiments of the present invention, polyethylene glycol having a molecular weight of about 1500 Da was obtained from Sigma. In some embodiments, the polyethylene glycol composition has a relatively low molecular weight. In some embodiments, the polyethylene glycol composition has an average molecular weight of about 50,000 Da or less. In some embodiments, the polyethylene glycol composition has an average molecular weight of about 10,000 Da or less. In still other embodiments, the polyethylene glycol composition has an average molecular weight of about 2000 Da or less. In further embodiments, the polyethylene glycol composition has an average molecular weight of about 1500 Da.

In some embodiments, the polyethylene glycol composition is present in an amount of about 0 to 50 weight percent, for example, about 1, 5, 10, 15, 20, 25, 30, 35, 40, 45 or 50 weight percent. In some embodiments, polyethylene glycol composition is present in an amount of about 10 weight percent.

Embodiments of the present invention further provide a polymer composition comprising a polylactic acid polymer composition covalently bonded to (a) an acrylic acid composition present in an amount of about 0 to about 50 weight percent, and subsequently physically blended with or covalently bonded to (b) a polyethylene glycol composition having a lower average molecular weight and present in an amount of about 0 to about 50 weight percent. In some embodiments, the acrylic acid composition is present in an amount of about 3 to about 10 weight percent and/or the polyethylene glycol composition is present in an amount of about 10 weight percent.

According to other embodiments of the present invention, the stiffening polymer composition and/or toughening polymer composition can include functional groups selected from the group consisting of hydroxyl, carboxyl, halo, glycidyl, cyano, amino carbonyl, thiol, sulfonic and sulfonate, including any combination thereof. The functional groups can be conjugated to a variety of biomolecules including, for example, amine or hydroxyl groups, using carbodiimide, thionyl chloride or phosphorous pentachloride chemistry as an example. Thus, according to some embodiments of the present invention, the polymer composition comprises an acrylic acid composition and/or a polyethylene glycol composition including the functional groups as described.

Embodiments of the present invention further provide polymer compositions having improved mechanical properties. Mechanical properties include, but are not limited to strength, elongation, modulus, stress and/or toughness. These properties can be measured using tests well known to those skilled in the art and discussed in greater detail in the Examples section presented below.

In some embodiments of the present invention, the polymer composition has improved toughness compared to conventional polylactic acid polymer compositions such as those that are composed primarily of polylactic acid. In some embodiments, the polymer compositions of the present invention show up to about a 10-fold increase in toughness. In some embodiments, the increase is 2-fold, 3-fold, 5-fold or 10-fold. In other embodiments, the polymer composition does not exhibit significant modulus and/or ultimate tensile strength losses compared to conventional polylactic acid polymer compositions such as those that are composed primarily of polylactic acid. Embodiments of the present invention further provide a polymer composition that can be extruded under conditions using a lower rotating screw speed compared to conventional polylactic acid polymer compositions such as those that are composed primarily of polylactic acid. In some embodiments, the rotating screw speed is between about 100 rpm and about 50 rpm. In some embodiments, the rotating screw speed is between about 50 rpm and about 20 rpm. In some embodiments, the rotating screw speed is not less than 20 rpm. In some embodiments, the rotating screw speed is about 20 rpm.

Moreover, in some embodiments, the polymer composition can be sufficiently heated during an extrusion process using a lower temperature compared to conventional polylactic acid polymer compositions such as those that are composed primarily of polylactic acid. In some embodiments, the polymer composition can be sufficiently heated during the extrusion process at a temperature in a range of about 170° C. to about 190° C. In some embodiments, the polymer composition can be sufficiently heated during the extrusion process at a temperature of about 170° C.

Embodiments of the present invention also provide a film formed from a polymer composition comprising a polylactic acid polymer composition grafted to (a) a stiffening polymer composition, and subsequently physically blended with or covalently bonded to (b) a toughening polymer composition. The stiffening polymer composition and toughening polymer composition have been described previously.

In embodiments where the stiffening polymer composition is an acrylic acid composition, the acrylic acid composition may be present in an amount of about 0 to about 50 weight percent or 3 to about 10 weight percent. In embodiments wherein the toughening polymer composition is a polyethylene glycol composition, the polyethylene glycol composition may be present in an amount of about 0 to about 50 weight percent or 10 weight percent. The polylactic acid polymer, acrylic acid composition and polyethylene glycol composition have been described previously. In some embodiments, the film has a thickness of about 80±10 μm.

In particular embodiments, the films have improved mechanical properties. In particular embodiments, the films have improved toughness compared to conventional films such as those that are composed primarily of polylactic acid. In some embodiments, the films of the present invention show up to about a 10-fold increase in toughness. In some embodiments, the increase is 2-fold, 3-fold, 5-fold or 10-fold. In other embodiments, the films do not exhibit significant modulus and/or ultimate tensile strength losses compared to conventional polylactic acid polymer compositions such as those that are composed primarily of polylactic acid.

In further embodiments, the present invention provides fibers including the polymer compositions described herein. In some embodiments, the present invention provides beads including the polymer compositions described herein. Embodiments of the present invention also provide coatings including the polymer compositions described herein.

Embodiments of the present invention further provide articles that include the polymer compositions described herein. In particular embodiments, the articles including the polymer compositions described herein include packaging and biomedical products. Exemplary articles include, but are not limited to, fibers, fabrics and other textiles, microwavable trays, hot-fill applications, engineering plastics, compost bags, product packaging, food packaging, beverage packaging and disposable tableware. Exemplary biomedical products include, but are not limited to, sutures, screws, tacks, pins, plates, stents, dialysis products, drug delivery devices, tissue engineering material, implant, bioplastics and biofilms. In some embodiments of the present invention, the polymer compositions described herein can be used in surgical and/or orthopedic procedures such as repairing soft tissue damage, ligament damage, fractures, and/or meniscal damage as well as to close incisions, cuts and/or tears where the polymer compositions can be used to form the articles described herein. In some embodiments, the polymer composition described herein forms an artificial tendon and/or ligament, muscle replacement and/or biological implant. Since the polymer compositions described herein can be bioabsorbable, the articles described herein including the polymer compositions can be bioabsorbable and/or biocompatible.

Embodiments of the present invention further relate to a method of making a grafted polylactic acid polymer composition, comprising (a) mixing a polylactic acid polymer composition, an initiator and a stiffening polymer composition in a reaction vessel under conditions suitable to form a polymer composition comprising a blend of the polylactic acid polymer composition and a stiffening polymer composition, and (b) adding a toughening polymer composition to the reaction vessel under conditions suitable to form a blend of the polylactic acid polymer composition, the stiffening polymer composition and the toughening polymer composition to provide the grafted polylactic acid polymer composition.

The polylactic acid polymer composition, the stiffening polymer composition and the toughening polymer composition have been described previously. In some embodiments of making the grafted polylactic acid polymer composition, the stiffening polymer composition comprises an acrylic acid polymer composition and the toughening polymer comprises a polyethylene glycol polymer composition. In some embodiments, the acrylic acid polymer composition is present in an amount of about 0 to about 50 weight percent or about 3 to about 10 weight percent. In other embodiments, the acrylic acid composition is present in an amount of about 3 weight percent. In some embodiments, the polyethylene glycol polymer composition is present in an amount of about 0 to about 50 weight percent or about 10 weight percent. In some embodiments, the acrylic acid is present in an amount of about 10 weight percent. In some embodiments, the polyethylene glycol polymer composition has a lower average molecular weight. In some embodiments, the polyethylene glycol composition has an average molecular weight of about 50,000 Da or less. In some embodiments, the polyethylene glycol composition has an average molecular weight of about 20,000 Da or less. In some embodiments, the polyethylene glycol composition has an average molecular weight of about 10,000 or less. In still other embodiments, the polyethylene glycol composition has an average molecular weight of about 2000 Da or less. In further embodiments, the polyethylene glycol composition has an average molecular weight of about 1500 Da.

In some embodiments, the acrylic acid composition and/or the polyethylene glycol composition comprise functional groups selected from the group consisting of hydroxyl, carboxyl, halo, glycidyl, cyano, amino carbonyl, thiol, sulfonic and sulfonate as described above.

In still further embodiments, the polylactic acid polymer composition backbone for the grafted polylactic acid polymer composition is a homopolymer or is copolymerized with glycolides, lactones or other monomers. In further embodiments, the polylactic acid polymer composition backbone for the grafted polylactic acid polymer composition is about 50%, 45%, 40%, 35%, 30%, 25%, 20%, 15%, 10%, 5%, 1% or 0% glycolide, lactone or other monomer. In some embodiments, the polylactic acid polymer composition backbone for the grafted polylactic acid polymer composition comprises poly(lactic-coglycolic) acid (PLGA).

Any suitable radical polymerization initiator can be used in the methods of the present invention as understood by one skilled in the art. Initiators employed in the methods of the present invention include, but are not limited to, 1,1′-azobis(cyclohexanecarbonitrile), 2,2′-azobis(2-methylpropionamidine) dihydrochloride, 2,2′-azobis(2-methylpropionitrile), 4,4′-azobis(4-cyanovaleric acid), ammonium persulfate, hydroxymethanesulfinic acid monosodium salt dehydrate, potassium persulfate, sodium persulfate, 1,1-bis(tert-amylperoxy)cyclohexane, 1,1-bis(tert-butylperoxy)-3,3,5-trimethylcyclohexane, 1,1-bis(tert-butylperoxy)cyclohexane, 2,2-bis(tert-butylperoxy)butane, 2,4-pentanedione peroxide (Luperox® 224) solution˜34 wt. % in 4-hydroxy-4-methyl-2-pentanone and N-methyl-2-pyrrolidone, 2,5-bis(tert-butylperoxy)-2,5-dimethylhexane, 2,5-bis(tert-butylperoxy)-2,5-dimethylhexane, blend with calcium carbonate and silica, 2,5-di(tert-butylperoxy)-2,5-dimethyl-3-hexyne, 2,5-di(tert-butylperoxy)-2,5-dimethyl-3-hexyne, 2-butanone peroxide (Luperox® DDM-9) solution˜35 wt. % in 2,2,4-trimethyl-1,3-pentanediol diisobutyrate, 2-butanone peroxide, cumene hydroperoxide di-tert-amyl peroxide, dicumyl peroxide, lauroyl peroxide, tert-butyl hydroperoxide tert-butyl peracetate, tert-butyl peroxybenzoate and tert-butylperoxy 2-ethylhexyl carbonate, including any combination thereof. In some embodiments, the initiator is benzoyl peroxide. As understood by one skilled in the art, the reaction vessel can be any container suitable for housing the reactions. In some embodiments, the reaction vessel can be a suitable flask.

According to further embodiments of the present invention, after the polymer blend has been allowed to dry, the polymer blend can be subjected to an extrusion process wherein a rotating screw speed is lower compared to that used with conventional polylactic acid polymer compositions consisting essentially of polylactic acid. In some embodiments, the rotating screw speed is between about 100 rpm and about 50 rpm. In some embodiments, the rotating screw speed is between about 50 rpm and about 20 rpm. In some embodiments, the rotating screw speed is not less than about 20 rpm. In some embodiments, the rotating screw speed is about 20 rpm. In further embodiments, the heat applied to the polymer blend is a lower temperature compared to conventional polylactic acid polymer compositions consisting essentially of polylactic acid. In some embodiments, the heat applied to the polymer blend during the extrusion process is in a range between about 170° C. and about 190° C. In some embodiments, the heat applied to the polymer blend during the extrusion process is about 170° C.

The following non-limiting examples are provided to further illustrate the present invention.

### Example 1

### Experimental Details

### A. Materials.

PLA pellets (Mn˜110 kDa) were supplied by NatureWorks LLC. Acrylic acid (99.5% w/w) was obtained from Acros Organics (Geel, Belgium) and used as received without further purification. PEG (Mn˜1500 Da) was obtained from Sigma-Aldrich. Chloroform was purchased from VWR. Benzoyl peroxide (BPO) was obtained from Fluka Chemical Corporation.

### B. PLA Reactive Blending.

As shown in the scheme below, a predetermined amount of PLA was dissolved in 140 mL CHCl₃ at 100° C. for 1 h followed by addition of predetermined amounts of BPO and acrylic acid. The solution was allowed to stand at 100° C. for 10 min. PEG was added to the solution and kept at 100° C. for an additional hour. The solution was then cooled to room temperature and poured in a glass dish. The solution was kept at room temperature overnight and then transferred to a vacuum oven at 70° C. for 24 h and cooled in the vacuum oven to remove any residual chloroform.

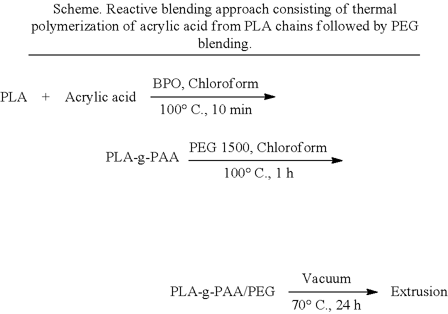

### C. Film Extrusion.

The polymer blend was immediately transferred to an extruder after drying. A twin-screw microextruder (DSM Xplore) operating in a co-rotating mode was used to cast films. The screws were tapered 170 mm long and the barrel volume was 15 cm³. The polymer melt exiting, the die was cooled by a stream of nitrogen gas and collected on a chill roll. The resultant films had a nominal thickness 80±10 μm.

### Example 2

### Characterization Protocols

### A. Mechanical Testing.

The film samples were stored at room temperature after extrusion for 24 h before mechanical testing. The mechanical properties of the film samples (7.5 cm×1.5 cm×80 μm) were measured using an Applied Test System Inc. (ATS) mechanical tester according to American Society for Testing and Materials Standard (ASTM D882) specifications. A cross-head speed of 1.25 cm/min was used. The measured values averaged for five specimens with ±95% confidence intervals are reported.

### B. Dynamic Mechanical Analysis (DMA).

A SEIKO INSTRUMENTS DMS210U dynamic mechanical analyzer, precalibrated using poly(methyl methacrylate) and steel standards, was used to monitor changes in the viscoelastic response of the material as a function of temperature. A film specimen (2 cm×1 cm×80 μm) was placed in mechanical oscillation at a frequency of 1 Hz and the test was conducted at a heating rate of 2° C./min.

C. Differential Scanning calorimetry (DSC).

A TA_{Instruments} DSC standard cell—2920 MDSC model was used to obtain DSC scans of melt-quenched samples. Approximately 5 mg sample was melted in the DSC cell followed by rapid quenching on a liquid nitrogen cooled stainless steel bar. This melt-quenched sample was scanned from 0 to 200° C. at a scan rate of 10° C./min.

### D. Toluidine Blue Staining.

Films were incubated in toluidine blue dye (0.1 mg/ml) for 1 h followed by washing with copious amounts of water to remove unattached dye. The films were dried at room temperature and photographed.

### Example 3

### Results

The scheme shown above represents the PLA reactive blending approach including thermal polymerization of acrylic acid from PLA chains followed by PEG blending. This technology offers PLA toughening with a better balance of properties associated with introduction of reactive acid groups into the PLA matrix. Briefly, PLA was thermopolymerized with acrylic acid using benzoyl peroxide (BPO) thermal initiator followed by blending with PEG in chloroform. The resultant blend was dried and extruded using a twin screw extruder operated in a co-rotating mode.

### A. Miscibility and Crystallization Behavior.

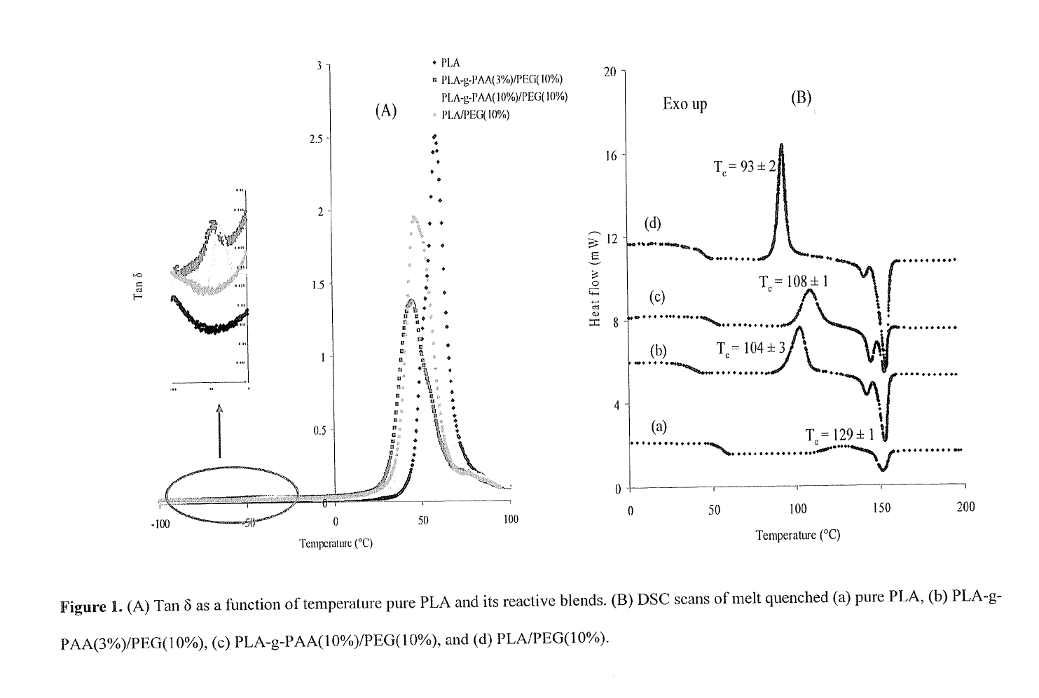

Miscibility and crystallization behavior of the films prepared using this chemistry was evaluated using DMA and DSC, respectively (FIG. 1). Blend miscibility is governed mainly by molecular weight and composition of the constituents. Since higher molecular weight, composition, or both of PEG phase showed a tendency to phase separate, relatively lower molecular weight PEG (Mₙ˜1500 Da) at a composition of 10% was used to blend with PLA, hereafter referred to as PLA/PEG(10%). PLA/PEG(10%) blends did not undergo any significant phase separation as characterized using DMA (FIG. 1A). Tan δ vs. temperature curve for PLA/PEG(10%) showed only one peak corresponding to PLA's T_{g}. When PLA was thermopolymerized with 3 or 10 wt % acrylic acid prior to blending with PEG, hereafter referred to as PLA-g-PAA(3%)/PEG(10%) or PLA-g-PAA(10%)/PEG(10%), a tan δ peak corresponding to the PEG phase was observed. This observation indicated that the PEG phase showed a phase separation tendency when blended with PLA-g-PAA (‘g’ denotes grafted).

When the PAA concentration was increased from 3 to 10 wt %, the tan δ peak (T_{g}) corresponding to the PEG phase shifted from −47±2.6° C. to −32±2.6° C. Additionally, T_{g} corresponding to the PLA phase increased from 43±2.1° C. to 48±1.7° C. These T_{g} shifts with composition indicated the partial miscibility of blend constituents. PLA is hydrophobic while PAA and PEG are hydrophilic. These observations also showed the possibility of favorable intermolecular polar interactions between PAA and PEG (as indicated by PEG's T_{g} shift with PAA concentration associated with phase separation) and between PAA and PLA (as indicated by PLA's T_{g} shift with PAA concentration). The crystallization temperature (T_{c}) of PLA decreased from 129±1° C. (FIG. 1B (a)) for neat PLA to 93±2° C. (FIG. 1B (d)) for PLA/PEG (10%) physical blend. The thermopolymerization of PAA with PLA, prior to blending with PEG, increased the T_{c} to 104±3° C. (FIG. 1B (b)) for PLA-g-PAA(3%)/PEG(10%) and to 108±1° C. (FIG. 1B (c)) for PLA-g-PAA(10%)/PEG(10%). This increase in T_{c} with PAA concentration supported the possibility of intermolecular polar interactions between PAA and PLA in PLA-g-PAA(3%)/PEG(10%) and PLA-g-PAA(10%)/PEG(10%) blends.

In order to study the effect of crosslinking, if any during PAA thermal polymerization, films were prepared using the same chemistry but excluding the PEG blending step, hereafter referred to as PLA-g-PAA(10%). It was observed that there was not any significant effect of PAA thermal polymerization step on PLA's T_{g} (as characterized using DMA). However, PLA's T_{c} decreased to 104±1° C. for PLA-g-PAA(10%) from 129±1° C. for neat PLA. These observations confirmed the possibility of intermolecular polar interactions affecting glass transition and crystallization events in PLA-g-PAA(3%)/PEG(10%) and PLA-g-PAA(10%)/PEG(10%) blends and not the crosslinking, if any occurring during PAA thermal polymerization.

### B. Toughness.

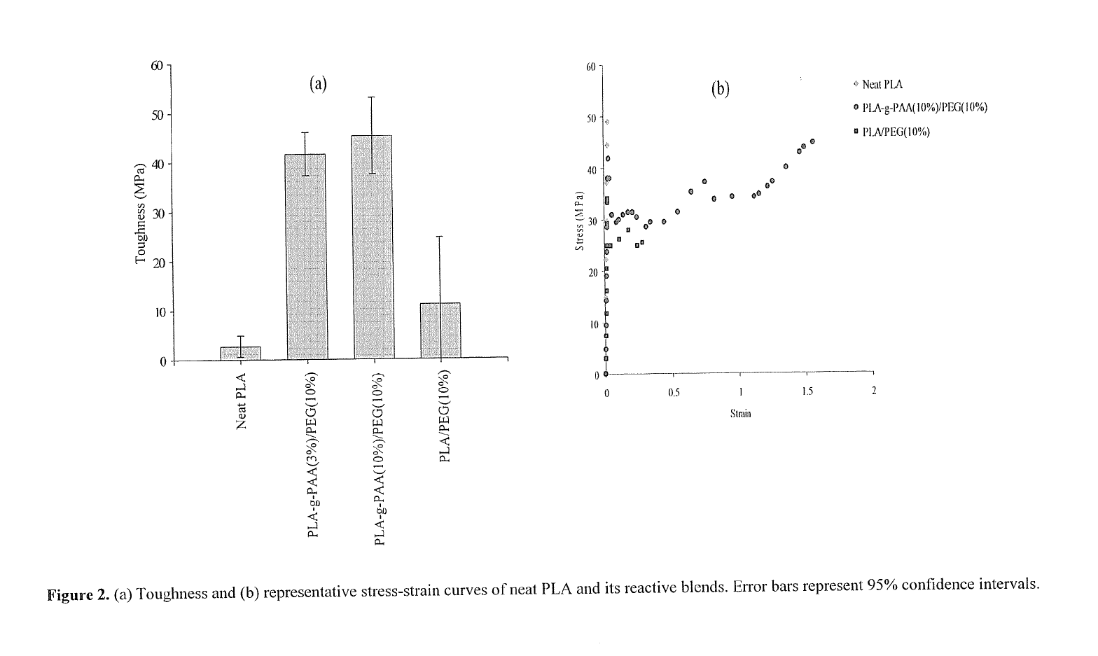

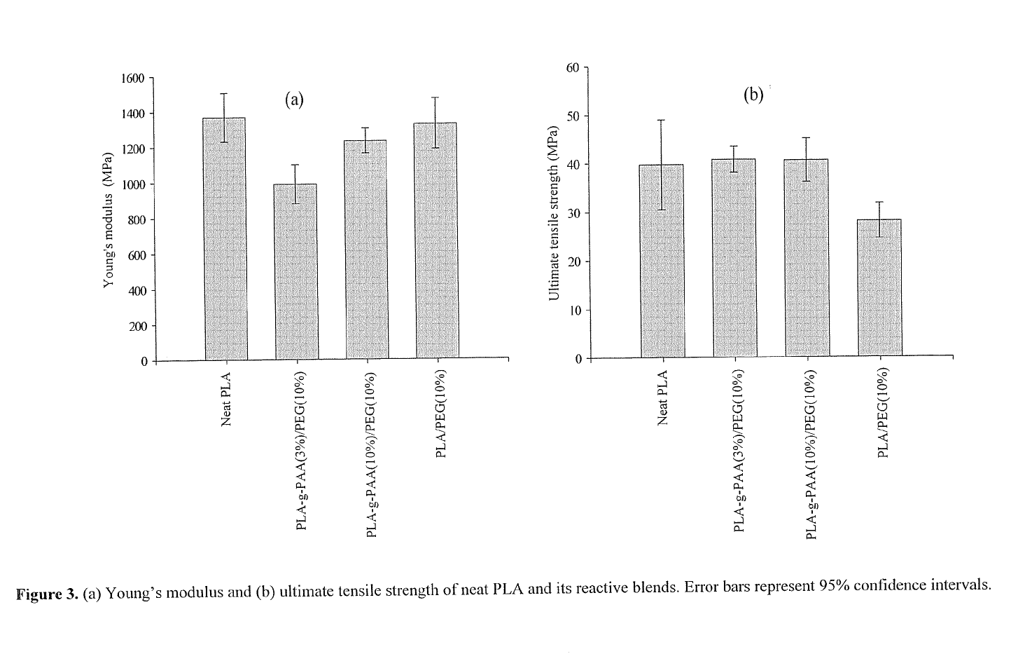

There was not any significant increase in the toughness of the PLA/PEG(10%) physical blend, as represented by the area under engineering stress-strain curve (FIG. 2). Thermopolymerization of 3 wt % acrylic acid, prior to PEG blending, resulted in significant toughness improvement (FIG. 2a). FIG. 2b shows the engineering stress-strain curves of these reactive blends. The toughness improvement appeared to be due, at least in part, to an increase in percent elongation at break from less than 10% for neat PLA to 150±20% for PLA-g-PAA(3%)/PEG(10%). As shown in FIG. 3, Young's modulus and ultimate tensile strength decreased slightly from 1370±130 MPa for neat PLA to 990±100 MPa for PLA-g-PAA(3%)/PEG(10%) and from 42±3 MPa to 35±3 MPa respectively (FIG. 3). Increase in acrylic acid content from 3 wt % to 10 wt %, retained the toughness of the films with insignificant Young's modulus (1235±70 MPa) and ultimate tensile strength (37±3 MPa) loss compared to neat PLA. This modulus and ultimate tensile strength retention was attributed, at least in part, to glassy (T_{g}˜125° C.) PAA chains. In addition to this, increase in T_{g} from 43±2.1° C. of PLA phase in PLA-g-PAA(3%)/PEG(10%) to 48±1.7° C. of PLA phase in PLA-g-PAA (10%)/PEG (10%), indicated the possibility of intermolecular polar interactions between PLA and PAA.

### C. Introduction of Reactive Acid Groups.

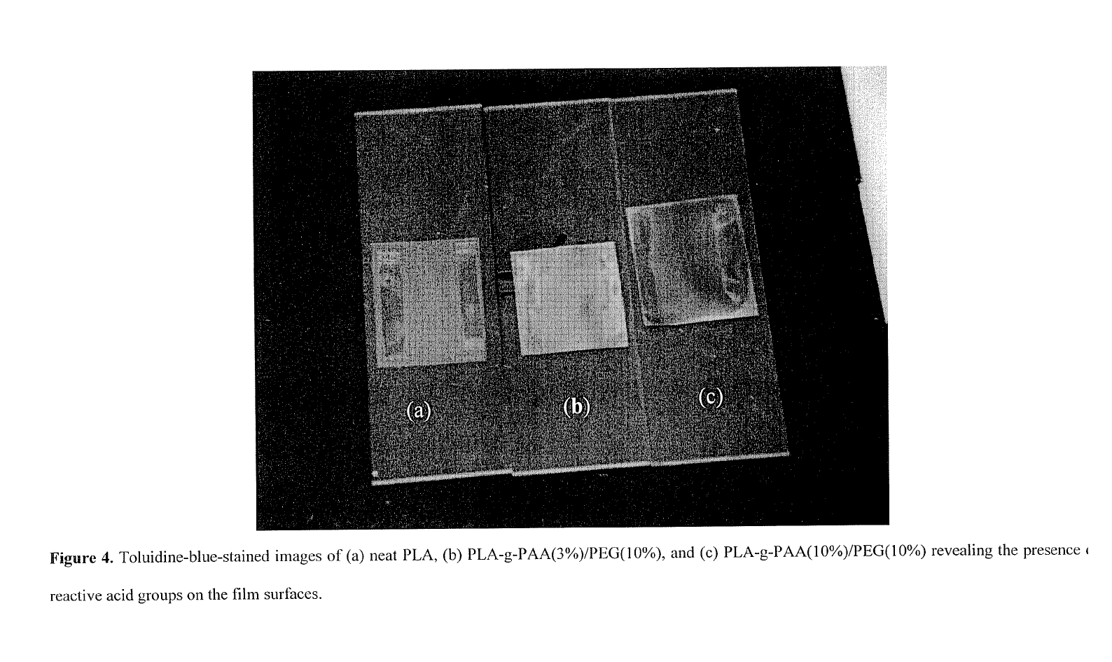

A further advantage this technology offers is the introduction of reactive acid groups into the PLA matrix for further modifications. As a proof-of-concept, these film surfaces were stained with toluidine blue dye. Toluidine blue is a cationic dye that readily binds with acid groups and not with PLA. Neat PLA did not show any significant staining (FIG. 4a). The color intensity increased with acid concentration (FIGS. 4b and 4c), indicating the presence of acid groups available for subsequent binding or conjugation.

This reactive blending technology offers PLA toughening without significant modulus and/or ultimate tensile strength loss associated with the introduction of reactive acid groups into the PLA matrix.

Although compositions of matter and methods of the present invention have been described in terms of specific embodiments and illustrative examples, it will be apparent to those of skill in the art that variations can be applied to the methods described herein without departing from the concept, spirit and scope of the invention. All such similar substitutes and modifications apparent to those skilled in the art are deemed to be within the spirit, scope and concept of the invention as defined by the appended claims.

1. A polymer composition comprising a polylactic acid polymer composition grafted to (a) a stiffening polymer composition, and subsequently physically blended with or covalently bonded to (b) a toughening polymer composition.

2. The polymer composition of claim 1, wherein the polylactic acid polymer composition is a homopolymer or copolymerized with glycolides or lactones.

3. The polymer composition of claim 1, wherein the stiffening polymer composition comprises an acrylic polymer.

4. The polymer composition of claim 1, wherein the stiffening polymer composition is selected from the group consisting of acrylic acid, acrylamide, methacrylic acid, methyl methacrylate, vinyl acetate, vinyl chloride, styrene, polystyrene, N-isopropylacrylamide, methyl acrylate, ethyl acrylate, butyl acrylate, 2-ethylhexyl acrylate, tertiarybutyl acrylate, tertiarybutyl methacrylate, isobutyl acrylate, 2-hydroxyethyl acrylate, 2-hydroxypropyl acrylate, butanediol monoacrylate, lauryl acrylate, dimethylaminoethyl acrylate, ethyldiglycol acrylate, cyclohexyl methacrylate, N-vinylformamid, N-vinylpyrrolidone, dihydrodicyclopentadienyl acrylate, dimethylaminoethyl acrylate, butanediol monoacrylate, 2-hydroxypropyl acrylate, 2-hydroxyethyl acrylate and 2-hydroxyethyl methacrylate.

5. The polymer composition of claim 1, wherein the toughening polymer composition comprises a polyether or a polyester.

6. The polymer composition of claim 1, wherein the toughening polymer composition is selected from the group consisting of polyethylene glycol, poly(ε-caprolactone), a poly(hydroxyl alkanoate) copolymer, poly(butylene adipate-co-terephthalate), poly(tetramethylene adipate-co-terephthalate), poly(para-dioxanone), poly(propylene carbonate) and poly(butylene succinate).

7. The polymer composition of claim 1, wherein the stiffening polymer composition and/or the toughening polymer composition is present in an amount of about 0 to about 50 weight percent.

8. The polymer composition of claim 1, wherein the stiffening polymer composition and/or the toughening polymer composition comprise functional groups selected from the group consisting of hydroxyl, carboxyl, halo, glycidyl, cyano, amino carbonyl, thiol, sulfonic and sulfonate.

9. A polymer composition comprising a polylactic acid polymer composition covalently bonded to (a) an acrylic acid polymer composition present in an amount of about 0 to about 50 weight percent, and subsequently physically blended with or covalently bonded to (b) a polyethylene glycol polymer composition present in an amount of about 0 to about 50 weight percent.

10. The polymer composition of claim 9, wherein the acrylic acid polymer composition and/or the polyethylene glycol polymer composition comprise functional groups selected from the group consisting of hydroxyl, carboxyl, halo, glycidyl, cyano, amino carbonyl, thiol, sulfonic and sulfonate.

11. A film formed from a polymer composition comprising a polylactic acid polymer composition grafted to (a) a stiffening polymer composition, and subsequently physically blended with or covalently bonded to (b) a toughening polymer composition.

12. A fiber comprising the polymer composition of claim 1.

13. An article comprising the polymer composition of claim 1.

14. The article of claim 13, wherein the article is a biomedical product selected from the group consisting of a suture, screw, tack, pin, plate, stent, dialysis product, drug delivery device, tissue engineering material, implant, bioplastic and biofilm.

15. A method of making a grafted polylactic acid polymer composition, comprising:
(a) mixing a polylactic acid polymer composition, an initiator and a stiffening polymer composition in a reaction vessel under conditions suitable to form a polymer composition comprising a blend of the polylactic acid polymer composition and the stiffening polymer composition; and
(b) adding a toughening polymer composition to the reaction vessel under conditions suitable to form a blend of the polylactic acid polymer composition, the stiffening polymer composition and the toughening polymer composition to provide the grafted polylactic acid polymer composition.

16. The method of claim 15, wherein the polylactic acid polymer composition is a homopolymer or copolymerized with a glycolide or a lactone.

17. The method of claim 15, wherein the polylactic acid polymer composition grafted to the stiffening polymer composition and the toughening polymer composition is physically blended with or covalently bonded to the polymer blend comprising the polylactic acid polymer composition and the stiffening polymer composition.

18. The method of claim 15, wherein the stiffening polymer composition and/or the toughening polymer composition is present in an amount of about 0 to about 50 weight percent.

19. The method of claim 15, wherein the stiffening polymer composition comprises an acrylic polymer.

20. The method of claim 15, wherein the stiffening polymer composition is selected from the group consisting of acrylic acid, acrylamide, methacrylic acid, methyl methacrylate, vinyl acetate, vinyl chloride, styrene, polystyrene, N-isopropylacrylamide, methyl acrylate, ethyl acrylate, butyl acrylate, 2-ethylhexyl acrylate, tertiarybutyl acrylate, tertiarybutyl methacrylate, isobutyl acrylate, 2-hydroxyethyl acrylate, 2-hydroxypropyl acrylate, butanediol monoacrylate, lauryl acrylate, dimethylaminoethyl acrylate, ethyldiglycol acrylate, cyclohexyl methacrylate, N-vinylformamid, N-vinylpyrrolidone, dihydrodicyclopentadienyl acrylate, dimethylaminoethyl acrylate, butanediol monoacrylate, 2-hydroxypropyl acrylate, 2-hydroxyethyl acrylate and 2-hydroxyethyl methacrylate.

21. The method of claim 15, wherein the toughening polymer composition comprises a polyether or a polyester.

22. The method of claim 15, wherein the toughening polymer composition is selected from the group consisting of polyethylene glycol, poly(ε-caprolactone), a poly(hydroxyl alkanoate) copolymer, poly(butylene adipate-co-terephthalate), poly(tetramethylene adipate-co-terephthalate), poly(para-dioxanone), poly(propylene carbonate) and poly(butylene succinate).

23. The method of claim 15, wherein the stiffening polymer composition and/or the toughening polymer composition comprise functional groups selected from the group consisting of hydroxyl, carboxyl, halo, glycidyl, cyano, amino carbonyl, thiol, sulfonic and sulfonate.

24. The method of claim 15, further comprising subjecting a dried polymer blend comprising polylactic acid, the stiffening polymer composition and the toughening polymer composition to an extrusion process using a lower rotating screw speed compared to that used with conventional polylactic acid polymer compositions consisting essentially of polylactic acid.

25. The method of claim 15, wherein the rotating screw speed is in a range of about 20 to about 50 rpm.
